(19) United States
(12) Patent Application Publication
(10) Pub. No.: US 2009/0084869 A1
(43) Pub. Date: Apr. 2, 2009

(54) Sprinkler guard

(76) Inventor: Yao Hui Lin, Monterey Park, CA (US)

Correspondence Address: DAVID AND RAYMOND PATENT FIRM, 108 N. YNEZ AVE., SUITE 128, MONTEREY PARK, CA, 91754, US

(21) Appl. No.: 11/904,725

(22) Filed: Sep. 28, 2007

(51) Int. Cl. B05B 15/06

(52) U.S. Cl. 239/201

(57) ABSTRACT

A sprinkler guard includes a hollow protector body adapted for being secured at the ground to encircle a sprinkler within a protector cavity and a retention slot formed at a bottom portion of the protector body and upwardly extended from a bottom opening edge of the protector body. The protector body is adapted for riding at an underground pipeline to retain the sprinkler within the protector body in position without blocking a sprinkling angle of the sprinkler within the protector cavity, wherein the retention slot is adapted for the underground pipeline passing through to let the sprinkler receiving within the protector cavity when the bottom portion of the protector body is inserted into the ground.

### BACKGROUND OF THE PRESENT INVENTION

1. Field of Invention

The present invention relates to a sprinkler guard, and more particularly to the sprinkler guard with a plurality of bottom openings at the lower portion thereof, wherein the bottom openings and an underground pipeline can form a ride-on structure to securely fasten the sprinkler guard on the ground. Moreover, the height of the sprinkler guard can be adjusted to avoid blocking the spraying angles of a sprinkler head received in the sprinkler guard.

2. Description of Related Arts

Irrigation sprinklers are often used on farms, golf courses and residential yards. Most irrigation sprinklers are buried in the ground along with some plumbing parts, pipelines and control equipment. One or more sprinkler heads are connected with the underground pipelines and the sprinkler system can be managed by a user and the sprinkler heads are designed to pop up daily and spray water for a predetermined period of time. More specifically, the sprinkler heads are located near the surface of the ground popped up in a pre-arranged manner to spray water, and restored to their original position after spraying water.

However, the sprinkler head is likely to be damaged during lawn maintenance by a tractor or a lawn mower, especially when the operator or user does not pay attention to the existing sprinkler heads. Also, the sprinkler heads may be broken when children are playing and running in the yard where the children may not aware of the existence of the sprinkler heads. The sprinkler head may be replaced or fixed, but it is both labor and time consuming. One may need to dig around the sprinkler head to replace or fix it, and the situation can be even worse when the ground is frozen during winter time in some places.

Some sprinkler guards are developed to protect the sprinkler head from damage. However, some of these sprinkler guards cannot be securely fastened on the ground such that when external impact is exerted thereon by the tractor or the lawn mower, the sprinkler guard is likely to be disengaged and lose its protective function. Furthermore, most of the conventional sprinkler guards have predetermined heights which may block some angles of the sprinkler head from spraying water as it is supposed to, especially when the sprinkler head is shorter than the sprinkler guard.

### SUMMARY OF THE PRESENT INVENTION

A main object of the present invention is to provide a sprinkler guard, wherein the sprinkler guard has a plurality of retention slots at the lower portion thereof, and the retention slots and an underground pipeline can form a ride-on structure to securely fasten the sprinkler guard on the ground. Also, the height of the sprinkler guard can be adjusted to avoid blocking the spraying angles of a sprinkler head received in the sprinkler guard.

Another object of the present invention is to provide a sprinkler guard, wherein the sprinkler guard comprises a protector body having a lower retention base defining the retention slots thereat and an upper adjustment housing coaxially and upwardly extended from the retention base to selectively adjust a height of the upper portion of the protector body with respect to the height of the sprinkler guard.

Another object of the present invention is to provide a sprinkler guard, wherein the adjustment housing is rotatably coupled with the retention base to selectively adjust the height of the upper portion of the protector body.

Another object of the present invention is to provide a sprinkler guard, wherein the adjustment housing is detachably coupled with the retention base to selectively adjust the height of the upper portion of the protector body.

Another object of the present invention is to provide a sprinkler guard, wherein the adjustment housing is slidably coupled with the retention base in a vertically movable manner to selectively adjust the height of the upper portion of the protector body.

Accordingly, in order to accomplish the above objects, the present invention provides a sprinkler guard for a sprinkler extended from an underground pipeline, comprising a hollow protector body and a retention structure.

The protector body has a protector wall, a protector cavity providing therewithin, an upper portion defining a top opening edge thereat, and a lower portion defining a bottom opening edge thereat, wherein the protector body is adapted for being secured at the ground to encircle the sprinkler within the protector cavity at a position that the lower portion of the protector body is mounted underneath the ground to retain the upper portion of the protector body in position for protecting the sprinkler at the upper portion of the protector body, wherein the upper portion of the protector body is upwardly protruded from the ground without blocking a sprinkling angle of the sprinkler within the protector cavity.

The retention structure contains one or more retention slots formed at the bottom portion of the protector body and upwardly extended from the bottom opening edge of the protector body, wherein each of the retention slots has a width larger than a diameter of the underground pipeline, wherein the protector body is adapted for riding at the underground pipeline to retain the sprinkler within the protector body in position that the retention slot is adapted for the underground pipeline passing through to let the sprinkler receiving within the protector cavity when the bottom portion of the protector body is inserted into the ground.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a sprinkler guard protecting a sprinkler therewithin according to a preferred embodiment in the present invention.

FIG. 2 is a sectional view of the sprinkler guard according to the preferred embodiment in the present invention.

FIG. 3 is a schematic view of a first alternative mode of the sprinkler guard according to the preferred embodiment in the present invention.

FIG. 4 is a schematic view of a second alternative mode of the sprinkler guard according to the preferred embodiment in the present invention.

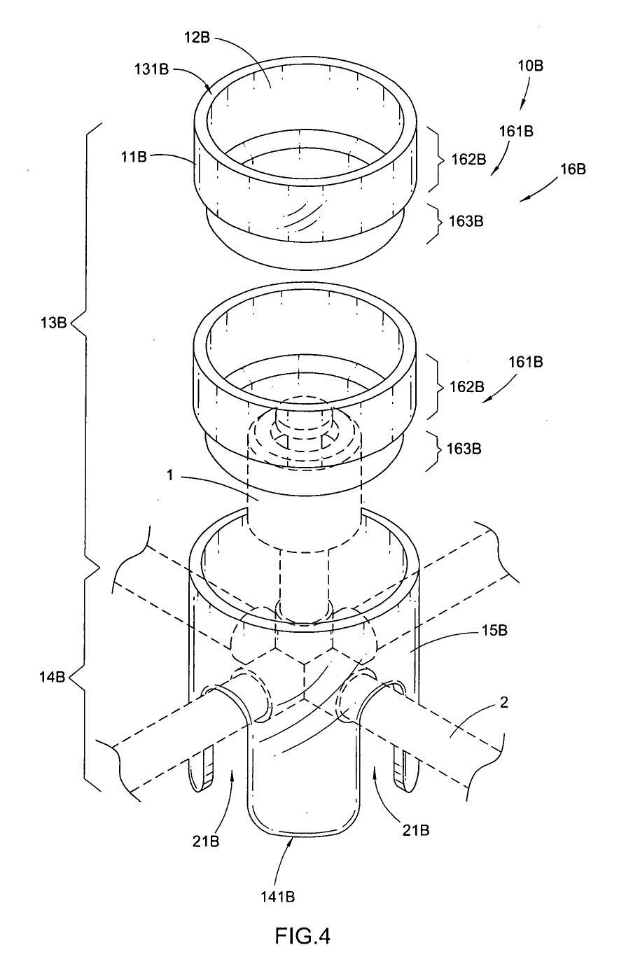

FIG. 5 is a schematic view of a third alternative mode of the sprinkler guard according to the preferred embodiment in the present invention.

FIG. 6 is a schematic view of a sprinkler guard protecting a sprinkler therewithin according to a second preferred embodiment in the present invention

### DETAILED DESCRIPTION OF THE PREFERRED EMBODIMENT

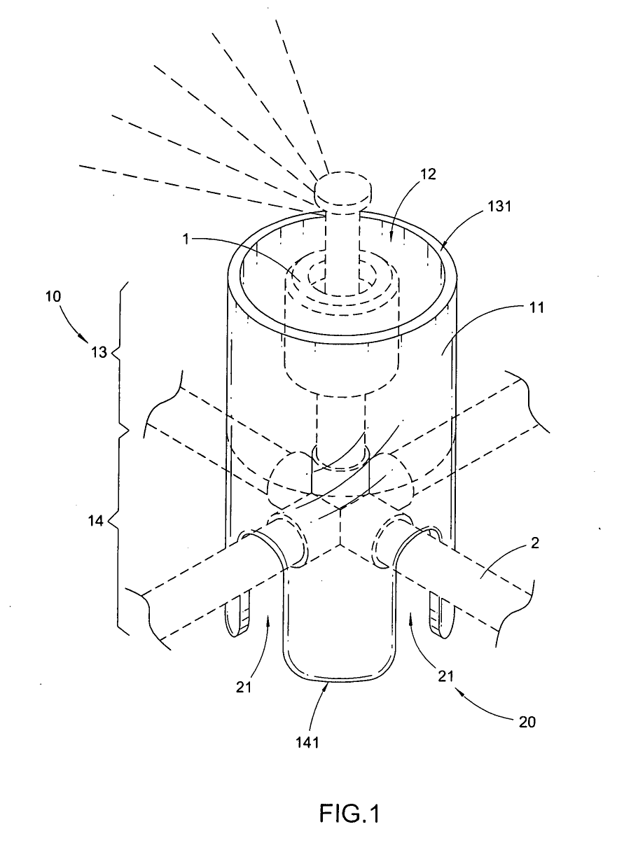

Referring to FIG. 1 and of the drawings, a sprinkler guard according to preferred embodiment of the present invention is illustrated, wherein the sprinkler guard, which is adapted for protecting for a sprinkler 1 extended from an underground pipeline 2, comprises a hollow protector body 10 and a retention structure 20.

The protector body 10 has a protector wall 11, a protector cavity 12 providing therewithin, an upper portion 13 defining a top opening edge 131 thereat, and a lower portion 14 defining a bottom opening edge 141 thereat, wherein the protector body 10 is adapted for being secured at the ground to encircle the sprinkler 1 within the protector cavity 12 at a position that the lower portion 14 of the protector body 10 is mounted underneath the ground to retain the upper portion 13 of the protector body 10 in position for protecting the sprinkler 1 at the upper portion 13 of the protector body 10. The upper portion 13 of the protector body 10 is upwardly protruded from the ground without blocking a sprinkling angle of the sprinkler 1 within the protector cavity 12 as shown in FIG. 1. Accordingly, the protector body 10 is preferably made of rigid, durable and waterproof material such as plastic.

The retention structure 20 contains one or more retention slots 21 formed at the bottom portion 14 of the protector body 10 and upwardly extended from the bottom opening edge 141 of the protector body 10, wherein each of the retention slots 21 has a width larger than a diameter of the underground pipeline 2. Accordingly, the protector body 10 is adapted for riding at the underground pipeline 2 to retain the sprinkler 1 within the protector body 10 in position that the retention slot 21 is adapted for the underground pipeline 2 passing through to let the sprinkler 1 receiving within the protector cavity 12 when the bottom portion 14 of the protector body 10 is inserted into the ground.

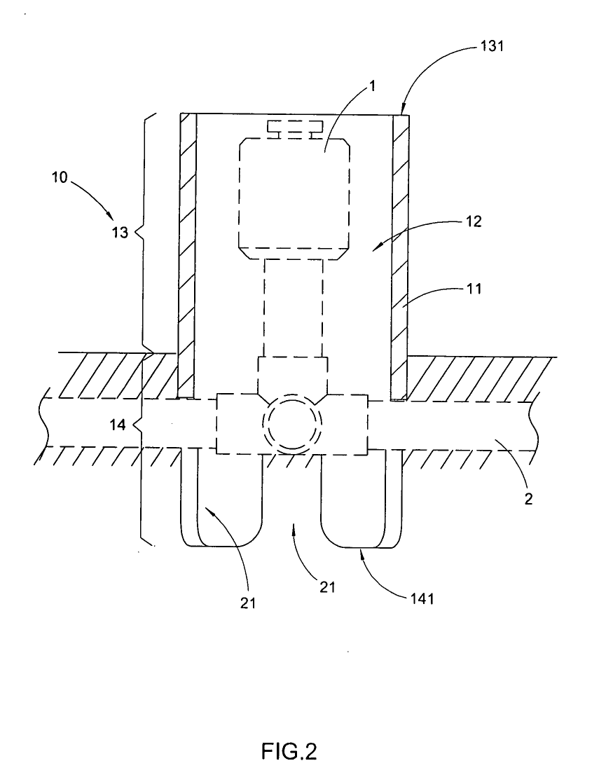

As shown in FIGS. 1 and 2, the protector body 10 has cylindrical shape that a size of the top opening edge 131 equals to a size of the bottom opening edge 141. The protector cavity 12 is big enough to receive the sprinkler 1 therein and is adapted for the user to access the sprinkler 1 without removing the protector body 10 from the ground. In other words, the user is able to mount or detach the sprinkler 1 to or from the underground pipeline 2 within the protector cavity 12.

Preferably, the protector body 10 is mounted at the ground at a position that the top opening edge 131 of the protector body 10 is normally retained above a top end of the sprinkler 1, as shown in FIG. 2, wherein the sprinkler 1 will sprinkle water at the top end thereof. Therefore, the protector wall 11 of the protector body 10 will not block the sprinkling angle of the sprinkler 1 during sprinkling operation thereof as shown in FIG. 1. It is worth mentioning that the height of the top opening edge 131 is slightly higher than the top end of the sprinkler 1. In other words, the top end of the sprinkler 1 inside the protector cavity 12 is slightly lower than the top opening edge 131, such that when there is any external force coming from the top, the sprinkler guard can provide better protection if the sprinkler 1 is entirely inside the protector cavity. In addition, during sprinkling operation, the sprinkler head of the sprinkler I will automatically lifted up by the water pressure such that the sprinkler head of the sprinkler 1 is positioned above the top opening edge 131 of the protector body 10, as shown in FIG. 1.

As shown in FIG. 1, the retention structure 20 contains four retentions slots 21 evenly formed at the bottom portion 14 of the protector body 10, wherein the retention slots 21 are aligned with each other. Therefore, the protector body 10 is adapted to ride at the elongated underground pipeline through the two corresponding opposed retention slots 21 or to ride at the right-angled underground pipeline through the two corresponding adjacent retention slots 21.

It is worth mentioning that the ride-on structure in the present invention can effectively resist the impact exerted by external forces. More specifically, the user pushes down the sprinkler guard until the retention slots 21 securely engage with the underground pipeline 2. Once the underground pipeline 2 passes from one side to the other side of the retention slot 21, the sprinkler guard is tightly engaged with the underground pipeline 2 so as to allow the sprinkler guard to resist external forces coming from the side, such as from the tractor or the lawn mower. In other words, since the external forces applied to the sprinkler guard are usually from the side, the ride-on structure can effectively protect the sprinkler head inside the sprinkler guard.

According to the preferred embodiment, the protector body 10 can be selectively adjust a height of the upper portion 13 of the protector body 10 with respect to the ground for matching the height of the sprinkler 1 by pressing down the protector body 10 at the ground until the top opening edge 131 of the protector body is positioned slightly above the top end of the sprinkler 1.

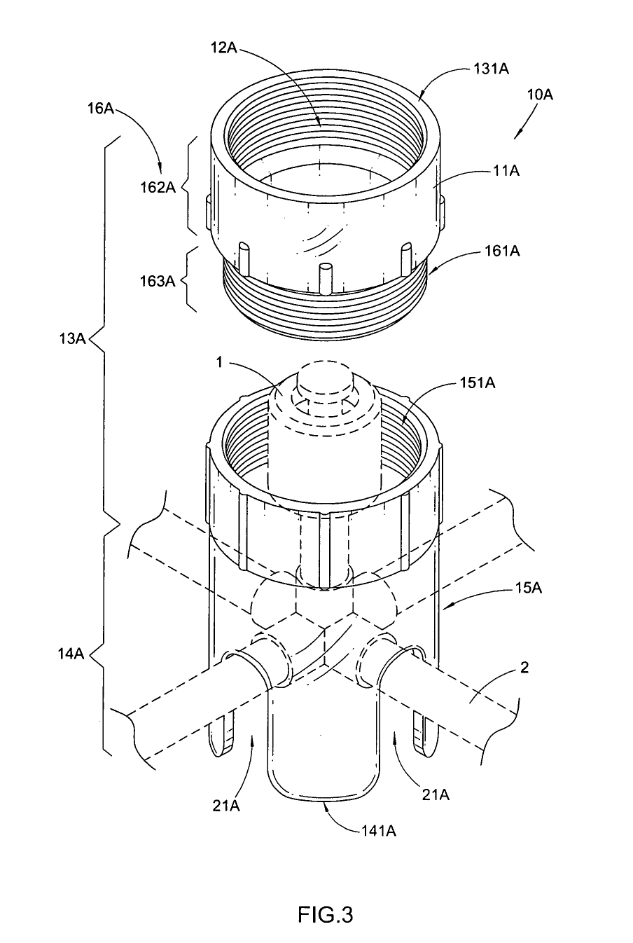

FIG. 3 illustrates an alternative mode of the protector body 10A being selectively adjust a height of the upper portion 13A of the protector body 10A with respect to the ground for matching the height of the sprinkler 1.

As shown in FIG. 3, the protector body 10A comprises a lower retention base 15A defining the retention slots 21A thereat and an upper adjustment housing 16A coaxially and upwardly extended from the retention base 15A to selectively adjust a height of the upper portion 13A of the protector body 10A with respect to a height of the sprinkler 1. The adjustment housing 16A is rotatably coupled with the retention base 15A to selectively adjust the height of the upper portion 13A of the protector body 10A.

The retention base 15A has an inner threaded portion 151A provided at an inner peripheral side of the retention base 15A. Correspondingly, the adjustment housing 16A has an outer threaded portion 161A provided at an outer peripheral side of the adjustment housing 16A and rotatably engaged with the inner threaded portion 151A of the retention base 15A such that when the retention base 15A is mounted at the ground to ride at the underground pipeline 2, the adjustment housing 16A is rotated to adjust the height of the upper portion 13A of the protector body 10A.

Accordingly, the adjustment housing 16A has an upper hollow section 162A having a circumferential size matching with a circumferential size of the retention base 15A and a lower hollow section 163A having a circumferential size smaller than the circumferential size of the upper hollow section 162A, wherein the outer threaded portion 161A is formed at the outer peripheral side of the lower hollow section 163A of the adjustment housing 16A.

Therefore, when the protector body 10A rides at the underground pipeline 2 through the bottom opening edge 141A at the retention slot 21A by inserting the bottom portion 14A under the ground, the adjustment housing 16A is adjustably rotated until the top opening edge 131A of the protector body 10A is retained slightly above a top end of the sprinkler 1. As a result, the sprinkler 1 is encircled by the protector wall 11A within the protector cavity 12A.

Alternatively, the protector body 10B comprises a lower retention base 15B defining the retention slots 21B thereat and an upper adjustment housing 16B coaxially and upwardly extended from the retention base 15B to selectively adjust a height of the upper portion 13B of the protector body 10B with respect to a height of the sprinkler 1. The adjustment housing 16B is detachably coupled with the retention base 15B to selectively adjust a height of the upper portion 13B of the protector body 10B.

Accordingly, the adjustment housing 16B comprises a plurality of ring-shaped engaging blocks 161B detachably and coaxially coupling with the retention base 15B, wherein the engaging blocks 161B are selectively stacked up at the retention base 15B to adjust the height of the upper portion 13B of the protector body 10B.

Each of the engaging blocks 161B has an upper hollow section 162B having a circumferential size matching with a circumferential size of the retention base 15B and a lower hollow section 163B having a circumferential size smaller than the circumferential size of the upper hollow section 162B, wherein the engaging blocks 161B are stacked together when the lower hollow section 163B of one of the engaging blocks 161B is engaged with the upper hollow section 162B of another the engaging block 161B. For example, if the user needs to use two engaging blocks 161B to fulfill the purpose of protection of the sprinkler 1, the two engaging blocks 161B are stacked with each other and coupled on the retention base 15B.

Therefore, when the protector body 10B rides at the underground pipeline 2 through the bottom opening edge 141B at the retention slot 21B by inserting the bottom portion 14B under the ground, the engaging blocks 161B of the adjustment housing 16B are selectively stacked until the top opening edge 131B of the protector body 10B is retained slightly above a top end of the sprinkler 1. As a result, the sprinkler 1 is encircled by the protector wall 11B within the protector cavity 12B.

It is worth mentioning that the stacking scheme illustrated in this alternative mode can be applied to the alternative mode in FIG. 3. More specifically, the adjustment housing 16A has the inner threaded portion 151A and the outer threaded portion 161A, which can be engaged with another adjustment housing 16A with corresponding inner threaded portion 151A. In other words, the adjustment housing 16A can be stacked with each other to adjust the height of the upper portion 13A by engaging the inner threaded portion 151A of one adjustment housing 16A with the outer threaded portion 161A of another adjustment housing 16A. Also, to provide better protection, the top opening edge 131A is slightly higher than the sprinkler 1.

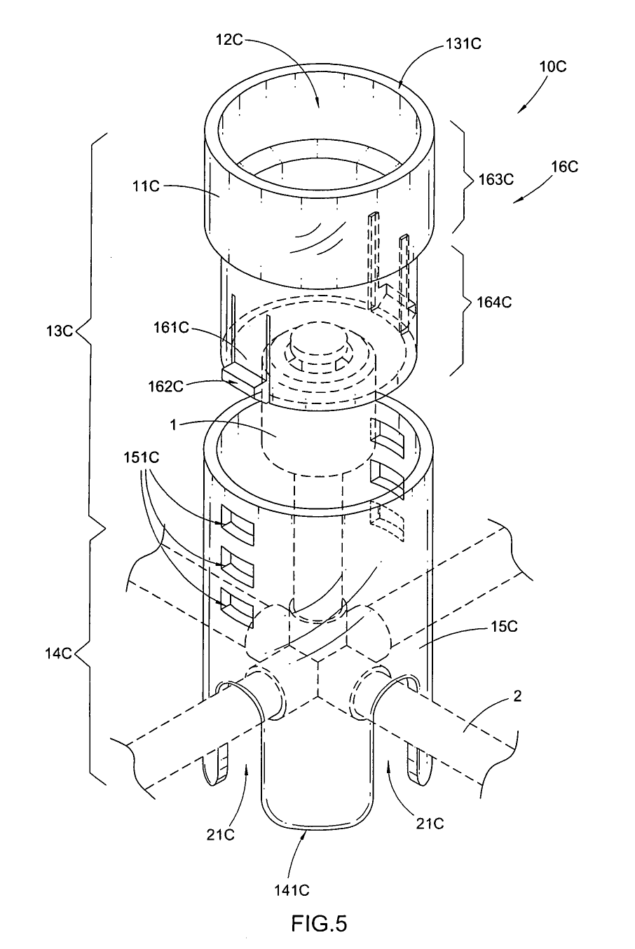

FIG. 5 illustrates another alternative mode of the protector 10C. The protector body 10C comprises a lower retention base 15C defining the retention slots 21C thereat and an upper adjustment housing 16C coaxially and upwardly extended from the retention base 15C to selectively adjust a height of the upper portion 13C of the protector body 10C with respect to the height of the sprinkler 1. The adjustment housing 16C is slidably coupled with the retention base 15C in a vertically movable manner to selectively adjust the height of the upper portion 13C of the protector body 10C.

Accordingly, the retention base 15C has a plurality of spaced apart through locking holes 151C alignedly formed at a peripheral wall of the retention base 15C at a transverse direction thereof. The adjustment housing 16C has a resilient arm 161C provided at a peripheral wall of the adjustment housing 16C and arranged to releaseably engage with one of the locking holes 151C to adjust the height of the upper portion 13C of the protector body 10C.

The resilient arm 161C, which is integrally formed at the peripheral wall of the adjustment housing 16C, has a hooking tip 162C protruding outwardly to selectively engage with one of the locking holes 151C.

The adjustment housing 16C has an upper hollow section 163C having a circumferential size matching with a circumferential size of the retention base 15C and a lower hollow section 164C having a circumferential size smaller than the circumferential size of the upper hollow section 163C, wherein the resilient arm 161C is formed at the peripheral wall of the lower hollow section 164C of the adjustment housing 16C.

Therefore, when the protector body 10C rides at the underground pipeline 2 through the bottom opening edge 141C at the retention slot 21C by inserting the bottom portion 14C under the ground, the resilient arm 161C of the adjustment housing 16C is selectively engaged with one of the locking holes 151C until the top opening edge 131C of the protector body 10C is retained slightly above a top end of the sprinkler 1. As a result, the sprinkler 1 is encircled by the protector wall 11C within the protector cavity 12C.

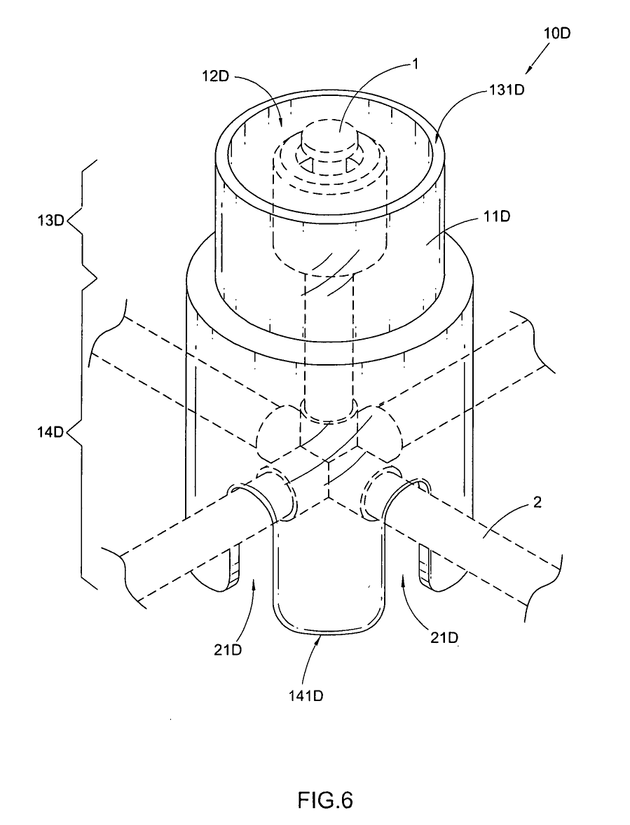

FIG. 6 illustrates an alternative mode of the protector body 10D defining an upper portion 13D of the protector body 10D with respect to the ground for matching the height of the sprinkler 1, and a lower retention base 15D defining the retention slots 21D thereat.

The protector body 10D has a protector wall 11D, a protector cavity 12D providing therewithin, an upper portion 13D defining a top opening edge 131D thereat, and a lower portion 14D defining a bottom opening edge 141D thereat, wherein the protector body 10D is adapted for being secured at the ground to encircle the sprinkler 1 within the protector cavity 12 at a position that the lower portion 14D of the proctor body 10D is mounted underneath the ground to retain the upper portion 13D of the protector body 10D in position for protecting the sprinkler 1 at the upper portion 13D of the protector body 10D. The upper portion 13D of the protector body 10D is upwardly protruded from the ground without blocking a sprinkling angle of the sprinkler 1 within the protector cavity 12D as shown in FIG. 6. It is worth mentioning that the lower portion 14D in this alternative is larger than the upper portion 13D so as to provide a more stable structure for the sprinkler guard to resist external forces especially coming from the side. More specifically, when the sprinkler guard has an enlarged lower portion 14D mounted underneath the ground, even if there are external forces coming from the side, the sprinkler guard is not easy to be disengaged from its original position.

As shown in FIG. 6, four retentions slots 21D evenly formed at the bottom portion 14D of the protector body 10D, wherein the retention slots 21D are aligned with each other. Therefore, the protector body 10D is adapted to ride at the elongated underground pipeline through the two corresponding opposed retention slots 21D or to ride at the right-angled underground pipeline through the two corresponding adjacent retention slots 21D.

It is worth mentioning that the sprinkler guard in the present invention is adapted to be used in the private yard. On the other hand, it can be widely used in golf courses, gardens, public parks to protect the sprinklers 1 therein. Also, the color of the sprinkler guard can be changed according to the color of the environment. For example, the color of the sprinkler guard is preferably to be green if it is used in the lawn, and if it is used in a garden with red flowers surrounded, the color of the sprinkler is preferably to be red.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-20. (canceled)

21. A sprinkler guard for a sprinkler extended from an underground pipeline, comprising:
a hollow protector body having a protector wall, a protector cavity providing therewithin, an upper portion defining a top opening edge thereat, and a lower portion integrally and downwardly extended from said upper portion to define a bottom opening edge thereat, wherein said protector body is adapted for being secured at the ground to encircle said sprinkler within said protector cavity at a position that said lower portion of said protector body is mounted underneath the ground to retain said upper portion of said protector body in position for protecting said sprinkler at said upper portion of said protector body, wherein said upper portion of said protector body is upwardly protruded from the ground without blocking a sprinkling angle of said sprinkler within said protector cavity; and
a retention structure containing one or more retention slots spacedly formed at said bottom portion of said protector body and upwardly extended from said bottom opening edge of said protector body, wherein each of said retention slots has a width slightly larger than a diameter of said underground pipeline and a depth substantially greater than said diameter of said underground pipeline so that said an upper portion of each of said retention slots is adapted for ridingly engaged at said underground pipeline so as to ridingly engage said protector body on said underground pipeline to retain said sprinkler within said protector body in position that said retention slot is adapted for said underground pipeline passing through to let said sprinkler receiving within said protector cavity when said bottom portion of said protector body is inserted into the ground.

22. The sprinkler guard, as recited in claim 21, wherein said protector body comprises a lower retention base defining said retention slots thereat and an upper adjustment housing coaxially and upwardly extended from said retention base to selectively adjust a height of said upper portion of said protector body with respect to a height of said sprinkler.

23. The sprinkler guard, as recited in claim 22, wherein said adjustment housing is rotatably coupled with said retention base to selectively adjust said height of said upper portion of said protector body.

24. The sprinkler guard, as recited in claim 23, wherein said retention base has an inner threaded portion provided at an inner peripheral side of said retention base, wherein said adjustment housing has an outer threaded portion provided at an outer peripheral side of said adjustment housing and rotatably engaged with said inner threaded portion of said retention base such that when said retention base is mounted at the ground to ride at said underground pipeline, said adjustment housing is rotated to adjust said height of said upper portion of said protector body.

25. The sprinkler guard, as recited in claim 24, wherein said adjustment housing has an upper hollow section having a circumferential size matching with a circumferential size of said retention base and a lower hollow section having a circumferential size smaller than said circumferential size of said upper hollow section, wherein said outer threaded portion is formed at an outer peripheral side of said lower hollow section of said adjustment housing.

26. The sprinkler guard, as recited in claim 21, wherein said protector body is mounted at the ground at a position that said top opening edge of said protector body is retained slightly higher than a top end of said sprinkler.

27. The sprinkler guard, as recited in claim 25, wherein said protector body is mounted at the ground at a position that said top opening edge of said protector body is retained slightly higher than a top end of said sprinkler.

28. The sprinkler guard, as recited in claim 21, wherein said protector body has cylindrical shape that a size of said top opening edge equals to a size of said bottom opening edge, wherein said retention slots are formed at said bottom portion of said protector body and are aligned with each other.

29. The sprinkler guard, as recited in claim 27, wherein said protector body has cylindrical shape that a size of said top opening edge equals to a size of said bottom opening edge, wherein said retention slots are formed at said bottom portion of said protector body and are aligned with each other.
